(19) United States
(12) Patent Application Publication
(10) Pub. No.: US 2014/0361060 A1
(43) Pub. Date: Dec. 11, 2014

(54) CAR TOP COMPARTMENT BOX

(71) Applicant: Formosa Saint Jose Corp., Taipei (TW)

(72) Inventor: Ming-Shun YANG, Taipei (TW)

(21) Appl. No.: 14/338,773

(22) Filed: Jul. 23, 2014

Related U.S. Application Data
(63) Continuation-in-part of application No. 13/645,131, filed on Oct. 4, 2012.

(51) Int. Cl. B60R 9/055

(52) U.S. Cl. CPC B60R 9/055
USPC 224/328

(57) ABSTRACT

Provided is a car top compartment box that includes a cover and a base. The cover includes a tight-fitting top plate layer and a first polymer foam layer and has a cover rim portion. The base includes a tight-fitting base layer and a second polymer foam layer. A concave receiving area is centrally defined at the base. The edge of the base extends outward and bends to form a lip edge portion corresponding in position to the cover rim portion. The car top compartment box is waterproof, lightweight, impact-resistant, thermally insulating, capable of buffering, and opened from the front or any lateral side to ensure the ease of access to items contained therein. The cover and the base are fully separable from each other to facilitate transport and reduce storage and transport space.

### CROSS-REFERENCE TO RELATED APPLICATIONS

The present CIP patent application claims the benefit of priority of U.S. patent application Ser. No. 13/645,131 which is entitled “Car Roof Storage Compartment With A Closed-End Zipper” filed on Oct. 4, 2012, and which is incorporated in full by reference herein.

### BACKGROUND OF THE INVENTION

1. Technical Field

The present invention relates to car top compartment boxes, and more particularly, to a car top compartment box effective in protecting items contained therein, capable of preventing water intrusion, and conducive to thermal insulation.

2. Description of Related Art

A conventional car top compartment box usually consists of an upper cover and a lower cover and is fixed to a roof baggage rack of the car, such that the car top compartment box forms a receiving space which is hermetically sealed.

However, with the conventional car top compartment box being mounted on the top of the car, the conventional car top compartment box is likely to crack whenever the car moves at high speed. The conventional car top compartment box is made from monolayer acrylonitrile butadiene styrene (ABS) or polypropylene (PP) and subjected to gusts of wind generated by the speeding car all the time; as a result, the conventional car top compartment box seldom provides thermal insulation to items contained therein. Furthermore, the items contained in the conventional car top compartment box are susceptible to crashes and cracks. For the above reasons, the conventional car top compartment box lacks ease of use.

Moreover, the conventional car top compartment box is too heavy to be held by most women or by just one man during a mounting or dismounting process, and its weight contributes to the vulnerability of the car body to collisions and scratches, thereby bringing inconvenience to users.

What is more, the conventional car top compartment box is not only made from rigid materials but is also too bulky to move; as a result, the upper cover and the lower cover of the conventional car top compartment box are inseparable from each other when the conventional car top compartment box is not in use. To overcome this drawback, users allocate an extra space inside the conventional car top compartment box to the items therein. But, the extra space causes a waste of space and difficulty in storage when the conventional car top compartment box is not in use.

Accordingly, it is imperative to devise and design a car top compartment box conducive to storage of items therein and access thereto, effective in protecting the items, and capable of providing thermal insulation to the items, to the advantage of car top compartment box users and car top compartment box manufacturers.

### SUMMARY OF THE INVENTION

The present invention relates to a car top compartment box which consists of a cover and a base. The cover essentially comprises a tight-fitting top plate layer and a first polymer foam layer and has a cover rim portion. The base is formed from a tight-fitting base layer and a second polymer foam layer. A concave receiving area is centrally defined at the base. The edge of the base extends outward and bends to fowl a lip edge portion corresponding in position to the cover rim portion. The present invention is advantageously characterized in that the car top compartment box is waterproof, lightweight, impact-resistant, thermally insulating, and capable of buffering. Furthermore, the car top compartment box opens from the front or any side and thus provides easy access to items contained therein. The cover and the base can be fully separated from each other to facilitate transport and reduce the required storage and transport space.

The present invention provides a car top compartment box, comprising: a cover including a tight-fitting top plate layer and a first polymer foam layer and having a cover rim portion; and a base including a tight-fitting base layer and a second polymer foam layer, wherein a concave receiving area is centrally defined at the base, and an edge of the base extends outward and bends to form a lip edge portion corresponding in position to the cover rim portion, wherein the top plate layer and the base layer are made of one of polypropylene (PP), acrylonitrile butadiene styrene (ABS), and polyethylene (PE), whereas the first polymer foam layer and the second polymer foam layer are made of one of ethylene vinyl acetate (EVA), low-density polyethylene (LDPE), and polyethylene (PE).

Implementation of the present invention involves the following inventive steps:

1. The car top compartment box is impact-resistant and shatterproof.

2. The car top compartment box is sturdy but lightweight.

3. The car top compartment box is buffer-enabled to protect items contained therein.

4. Items contained in the car top compartment box are prevented from sliding.

5. The car top compartment box is capable of thermal insulation.

6. The car top compartment box prevents intrusion of water droplets through a zipper and thus is fully waterproof.

7. The cover and the base are fully separable from each other and can be stacked in a cover-to cover and base-to-base manner, thereby enhancing the ease of transport and reducing the required storage space greatly.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1A is a schematic view of a car top compartment box of an embodiment of the present invention;

FIG. 1B is a cross-sectional view of the cover and the base of the embodiment of FIG. 1A;

FIG. 2 is a cross-sectional view of a car top compartment box according to another embodiment of the present invention;

FIG. 3A is a cross-sectional view of a car top compartment box with a zipper according to an embodiment of the present invention;

FIG. 3B is a cross-sectional view of a car top compartment box with a zipper according to another embodiment of the present invention;

FIG. 4 is a schematic view of a car top compartment box opened from a side according to an embodiment of the present invention;

FIG. 5 is a schematic view of a car top compartment box opened from the other side according to an embodiment of the present invention;

FIG. 6 is a schematic view of a car top compartment box opened from the head side according to an embodiment of the present invention;

FIG. 7A is a side view of a car top compartment box with supports according to an embodiment of the present invention;

FIG. 7B is a side view of another car top compartment box with supports according to an embodiment of the present invention; and

FIG. 8 is a schematic view of a car top compartment box with supports is installed on the roof baggage rack of a car according to an embodiment of the present invention.

### DETAILED DESCRIPTION OF THE EMBODIMENT OF THE INVENTION

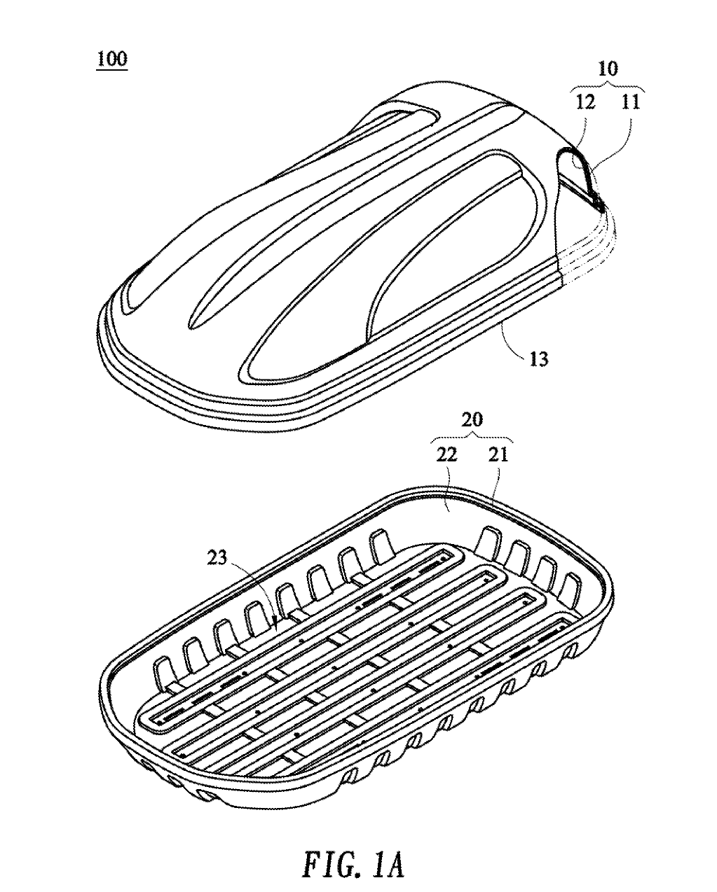

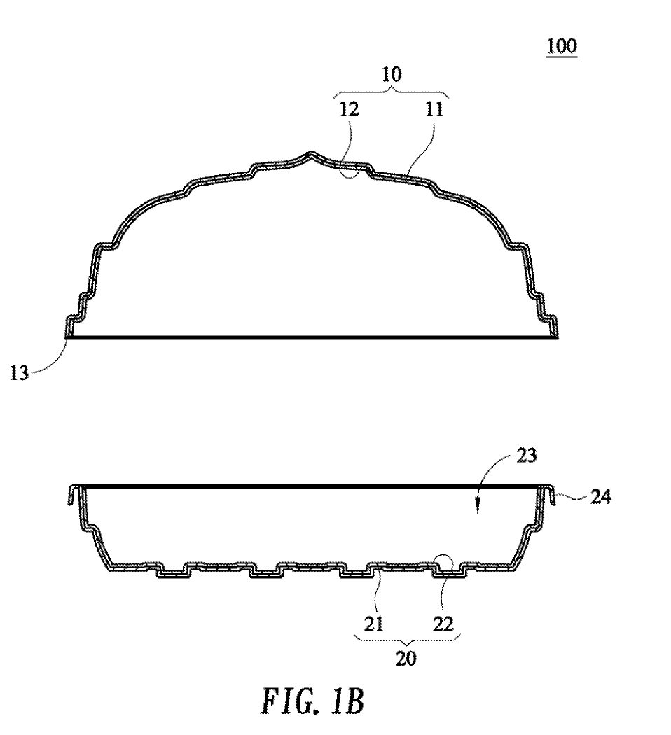

Referring to FIG. 1A, in an embodiment of the present invention, a car top compartment box 100 consists of a cover 10 and a base 20. Both the cover 10 and the base 20 are made of a lightweight plastic and a thermally-insulating elastic material which are coupled together and processed. Hence, the car top compartment box 100 is easy to make, lightweight, impact-resistant, shatterproof, and thermally insulating. Accordingly, the car top compartment box 100 is not only well suited to any cars, but can also be mounted and dismounted by a user independently.

Referring to FIG. 1A and FIG. 1B, the cover 10 essentially comprises a tight-fitting top plate layer 11 and a first polymer foam layer 12. Also, a cover rim portion 13 is formed at the edge of the cover 10. The top plate layer 11 is made of a lightweight but sturdy material, such as polypropylene (PP), acrylonitrile butadiene styrene (ABS) or polyethylene (PE). The first polymer foam layer 12 is made of a thermally-insulating elastic material, such as ethylene vinyl acetate (EVA), low-density polyethylene (LDPE), or polyethylene (PE).

Referring to FIG. 1A and FIG. 1B, the base 20 essentially comprises a tight-fitting base layer 21 and a second polymer foam layer 22. A concave receiving area 23 is centrally defined at the base 20. The edge of the base 20 extends outward and bends to form a lip edge portion 24 corresponding in position to the cover rim portion 13. Furthermore, to form the lip edge portion 24, the edge of the base 20 extends outward and bends by an angle larger than 90°, without coming into contact with the base 20.

Referring to FIG. 1A and FIG. 1B, the base layer 21 is made of polypropylene (PP), acrylonitrile butadiene styrene (ABS), or polyethylene (PE), whereas the second polymer foam layer 22 is made of ethylene vinyl acetate (EVA), low-density polyethylene (LDPE), or polyethylene (PE).

Referring to FIG. 1A and FIG. 1B, both the top plate layer 11 and the base layer 21 of the car top compartment box 100 are made of a lightweight but sturdy material and thus are of a thin thickness of 0.5 mm to 8 mm. The thinner the top plate layer 11 and the base layer 21, the lighter the car top compartment box 100, and thus the easier the mount and dismounting of the car top compartment box 100.

As the first polymer foam layer 12 and the second polymer foam layer 22 are elastic, lightweight, conducive to reduction in the weight of the car top compartment box 100, and capable of buffering, the car top compartment box 100 protects items contained therein against collisions and resultant damage.

Referring to FIG. 1A and FIG. 1B, both the first polymer foam layer 12 and the second polymer foam layer 22 of the car top compartment box 100 are of a thickness of 2 mm to 10 mm. The thicker the first polymer foam layer 12 and the second polymer foam layer 22, the better the protection and thermal insulation provided by the first polymer foam layer 12 and the second polymer foam layer 22.

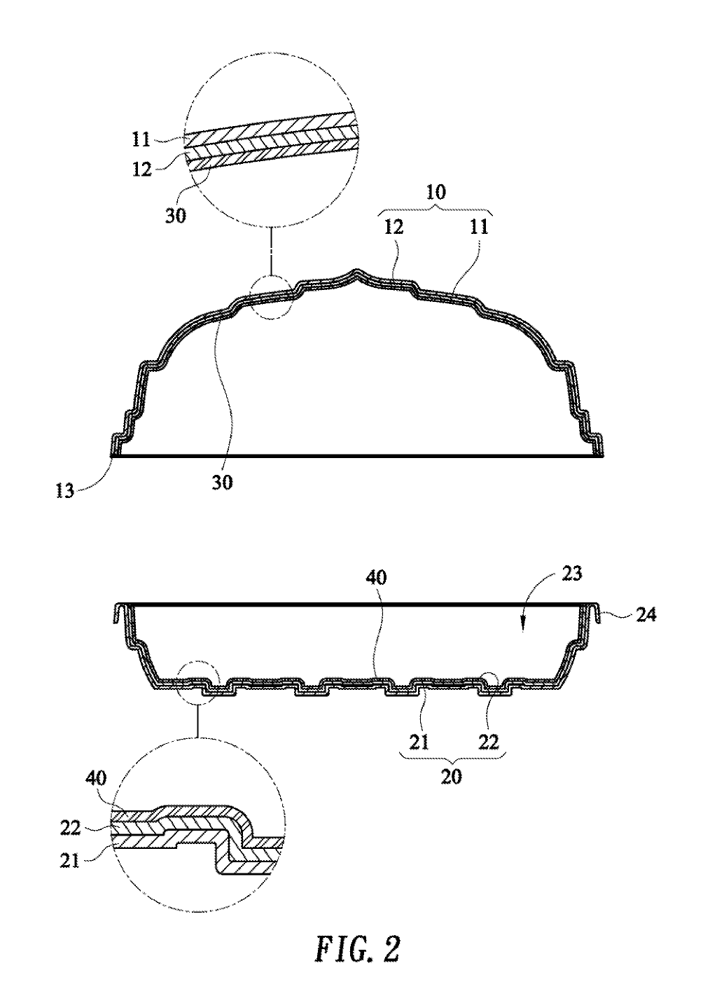

Referring to FIG. 2, to protect the first polymer foam layer 12 and the second polymer foam layer 22 from scratches and punctures, it is practicable that, after the first polymer foam layer 12 and the second polymer foam layer 22 have been coupled to the top plate layer 11 and the base layer 21, respectively, a first shielding layer 30 is adhered to the exposed side of the first polymer foam layer 12 to allow the first polymer foam layer 12 to be sandwiched between the top plate layer 11 and the first shielding layer 30, and a second shielding layer 40 is adhered to the exposed side of the second polymer foam layer 22 to allow the second polymer foam layer 22 to be sandwiched between the base layer 21 and the second shielding layer 40.

Hence, the cover 10 has a trilateral structure composed of the top plate layer 11, the first polymer foam layer 12, and the first shielding layer 30, whereas the base 20 has a trilateral structure composed of the base layer 21, the second polymer foam layer 22, and the second shielding layer 40.

Both the first shielding layer 30 and the second shielding layer 40 are made of polypropylene (PP), acrylonitrile butadiene styrene (ABS), polyethylene (PE), or fiber, and are advantageously lightweight and scratchproof.

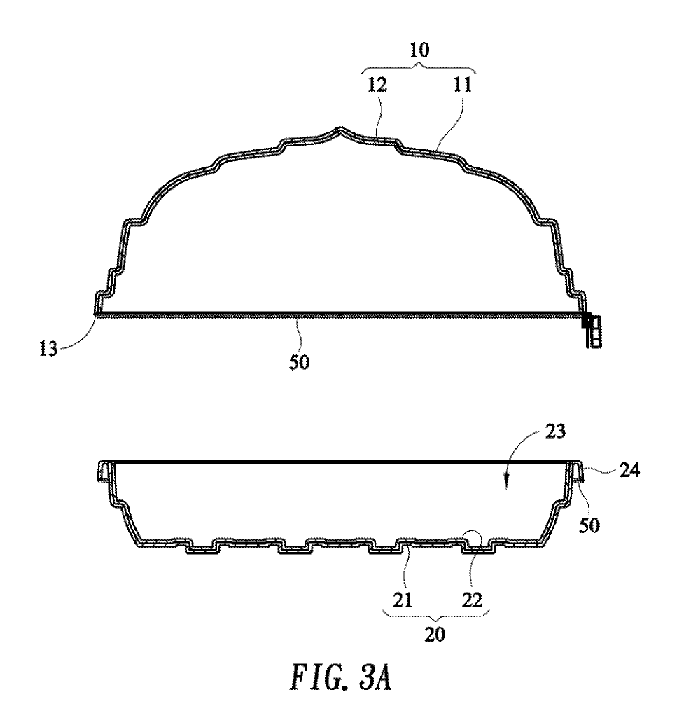

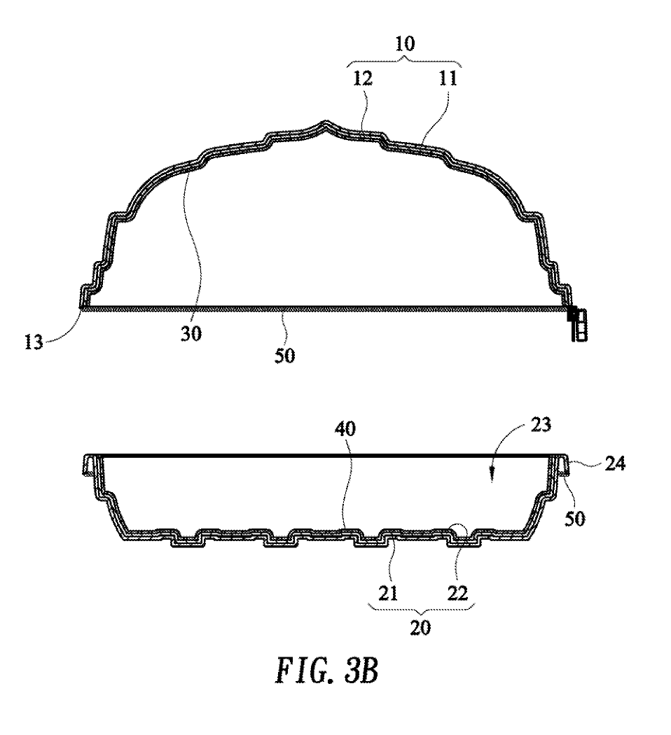

Please refer to FIG. 3A, the car top compartment box 100 further comprises a zipper 50 machine-sewed between the lip edge portion 24 and the cover rim portion 13. The zipper 50 comprises a slider which can be pulled by a user to effectuate full separation, partial separation, or tight-fitting engagement of the cover 10 and the base 20. Hence, the zipper 50 enhances the ease of access to items contained in the car top compartment box 100 and effectuates tight-fitting engagement of the cover 10 and the base 20 to shut in and protect the items therein.

Referring to FIG. 3B and FIG. 2, the zipper 50 is machine-sewed between the lip edge portion 24 and the cover rim portion 13 to effectuate full separation, partial separation, or tight-fitting engagement of the cover 10 having the first shielding layer 30 and the base 20 having the second shielding layer 40, so as to not only enhance the ease of access to items contained in the car top compartment box 100 but also effectuate tight-fitting engagement of the cover 10 and the base 20 to shut in and protect the items therein.

In practice, the car top compartment box 100 is fixed to a roof baggage rack by screws, by a means of snap-engagement, or by an appropriate means, and the present invention is not limited thereto.

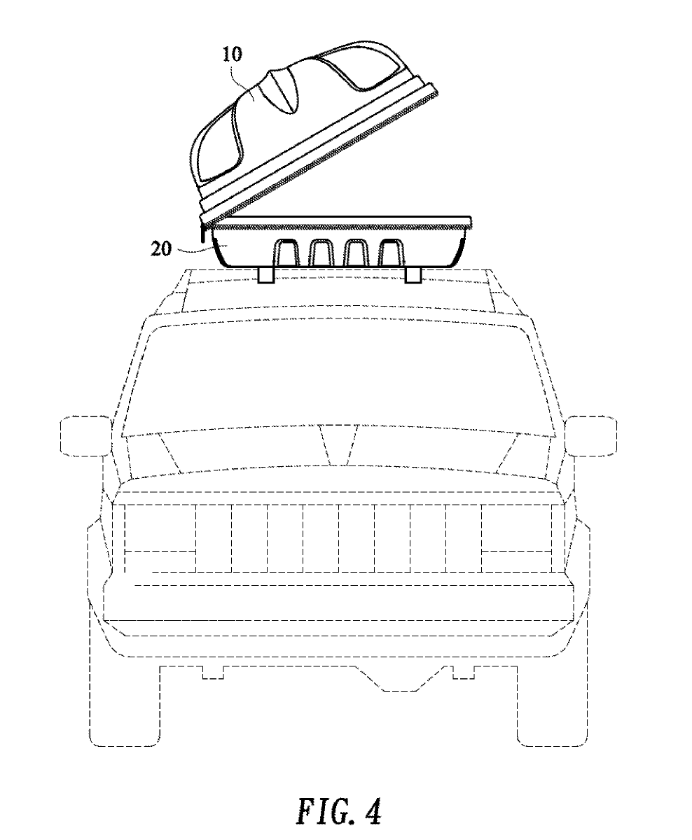

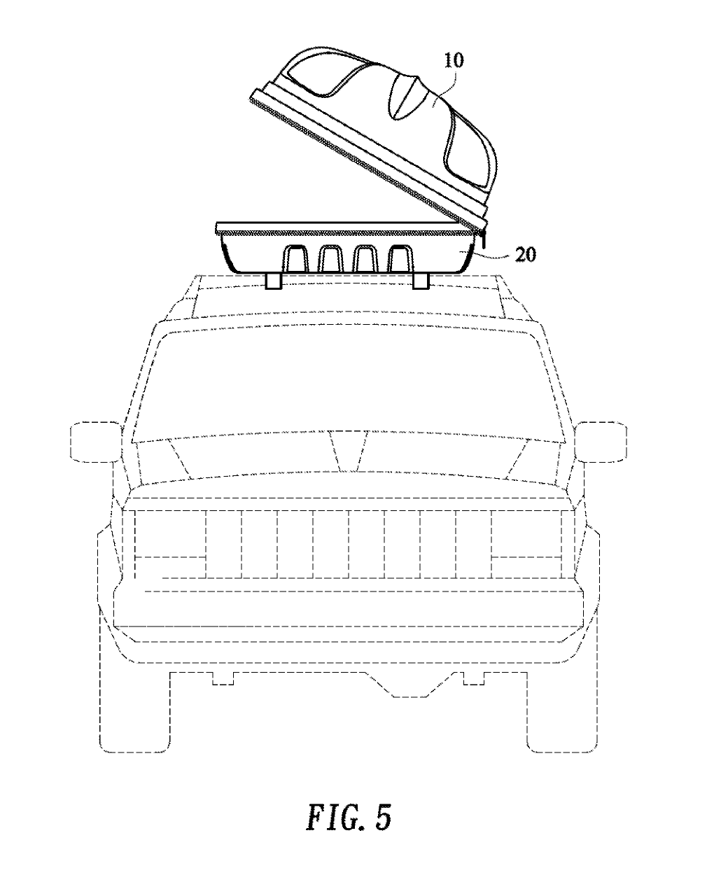

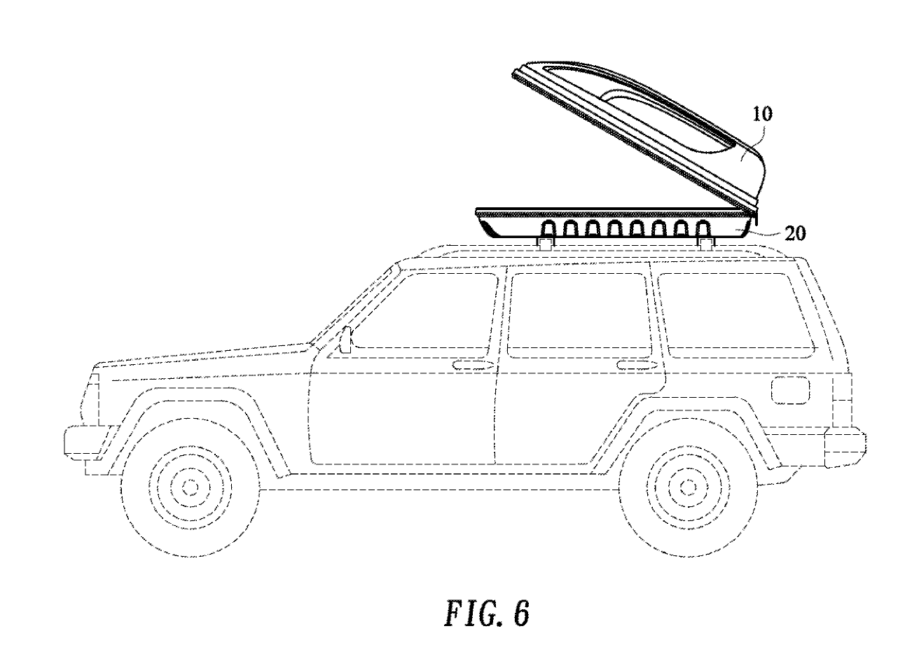

Referring to FIG. 4 through FIG. 6, there are shown schematic views of the car top compartment box 100 fixed to the roof baggage rack and opened in various manner according to various embodiments of the present invention, respectively. The opening/closing of the zipper 50 (and thus the car top compartment box 100) starts from the left (relative to the front of the car), from the right (relative to the front of the car), from the front (relative to the front of the car), or from the rear (relative to the front of the car), so as to enhance the ease of use of the car top compartment box 100. That is to say, the car top compartment box 100 can be opened from a side or the other side or from the front or from the rear side, to offer great convenience in use.

The edge of the base 20 extends outward and bends by an angle larger than 90° to form the lip edge portion 24. Due to the zipper 50 between the cover rim portion 13 and the bent lip edge portion 24, the cover 10 and the base 20 can be tightly coupled together at a lower position than the highest edge of the receiving area 23, water or foreign bodies (debris) cannot intrude into the car top compartment box 100 through any tiny gaps of the zipper 50 when the zipper 50 closes to effectuate tight-fitting engagement of the cover 10 and the base 20.

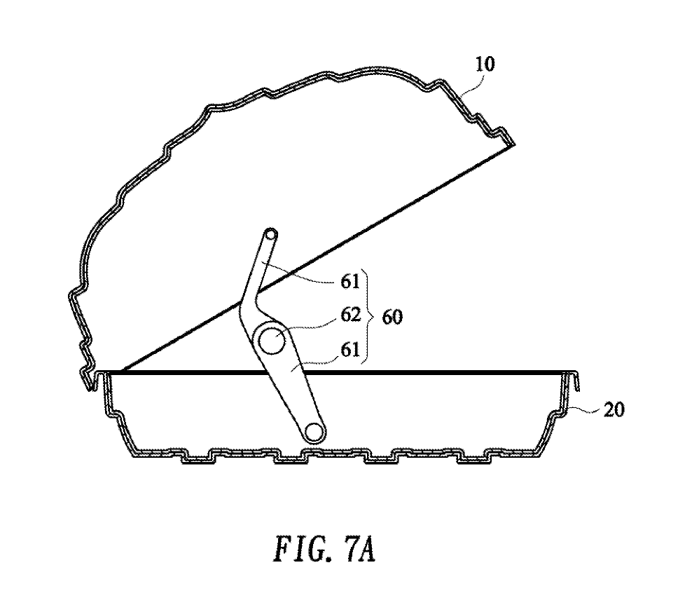

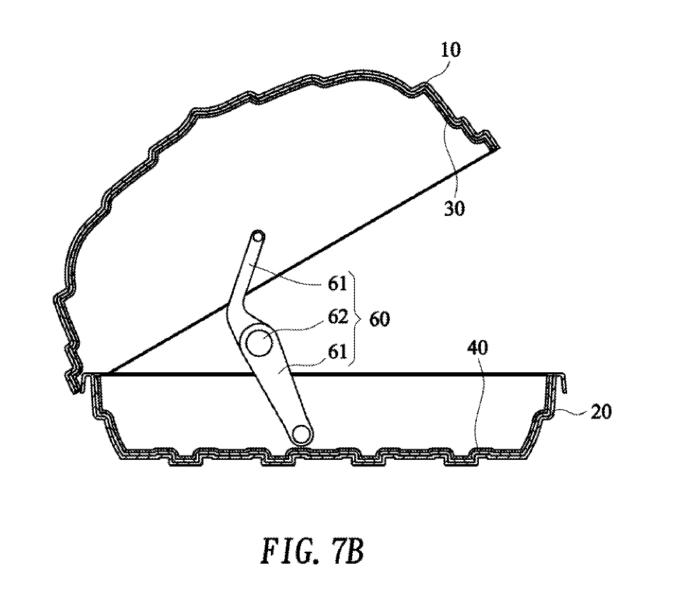

Referring to FIG. 3A and FIG. 7A, the cover 10 and the base 20 are coupled together by supports 60 instead of the zipper 50. Two supports 60 are fixed to two opposing lateral sides of the cover 10 and the base 20, respectively. The supports 60 do not come into contact with the lip edge portion 24 and thus is unlikely to scratch the lip edge portion 24.

Referring to FIG. 7A, the supports 60 each have two arms 61 and a pivot portion 62 which connects with one end of each of the two arms 61. The other ends of the two arms 61 are fixed to the same lateral sides of the cover 10 and the base 20, respectively. The two arms 61 rotate about the pivot portion 62, such that the cover 10 can be lifted off the base 20 and can cover the base 20 snugly.

Referring to FIG. 7B, in an embodiment of the present invention, the cover 10 having the first shielding layer 30 and the base 20 having the second shielding layer 40 are coupled together by the supports 60, and the two arms 61 rotate about the pivot portion 62, such that the cover 10 can be lifted off the base 20 and can cover the base 20 snugly.

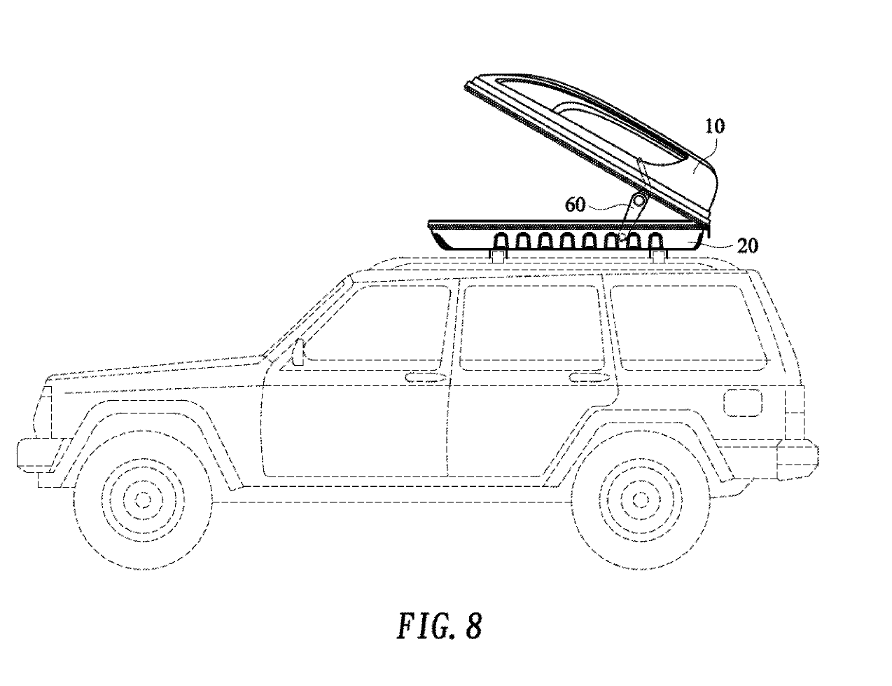

Referring to FIG. 8, in an embodiment of the present invention, the car top compartment box 100, of which the cover 10 and the base 20 are coupled together by the supports 60, is installed on the roof baggage rack of a car. At the moment when the cover 10 covers the base 20 snugly, the cover rim portion 13 and the lip edge portion 24 are in tight-fitting engagement whereby water and foreign bodies are prevented from intruding into the car top compartment box 100.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A car top compartment box, comprising:
a cover including a tight-fitting top plate layer and a first polymer foam layer and having a cover rim portion; and
a base including a tight-fitting base layer and a second polymer foam layer, wherein a concave receiving area is centrally defined at the base, and an edge of the base extends outward and bends to form a lip edge portion corresponding in position to the cover rim portion,
wherein the top plate layer and the base layer are made of one of polypropylene (PP), acrylonitrile butadiene styrene (ABS), and polyethylene (PE), whereas the first polymer foam layer and the second polymer foam layer are made of one of ethylene vinyl acetate (EVA), low-density polyethylene (LDPE), and polyethylene (PE).

2. The car top compartment box of claim 1, wherein a first shielding layer is adhered to the first polymer foam layer to allow the first polymer foam layer to be sandwiched between the top plate layer and the first shielding layer, and a second shielding layer is adhered to the second polymer foam layer to allow the second polymer foam layer to be sandwiched between the base layer and the second shielding layer, wherein the first shielding layer and the second shielding layer are made of one of polypropylene (PP), acrylonitrile butadiene styrene (ABS), polyethylene (PE), and fiber.

3. The car top compartment box of claim 1, further comprising a zipper machine-sewed between the lip edge portion and the cover rim portion to effectuate one of full separation, partial separation, and tight-fitting engagement of the cover and the base.

4. The car top compartment box of claim 2, further comprising a zipper machine-sewed between the lip edge portion and the cover rim portion to effectuate one of full separation, partial separation, and tight-fitting engagement of the cover and the base.

5. The car top compartment box of claim 1, wherein two supports are fixed to two opposing lateral sides of the cover and the base, respectively, without coming into contact with the lip edge portion, the supports each having two arms and a pivot portion connecting with an end of each of the two arms such that other ends of the two arms are fixed to same lateral sides of the cover and the base, respectively, wherein the two arms rotate about the pivot portion such that the cover can be lifted off the base and can cover the base snugly.

6. The car top compartment box of claim 2, wherein two supports are fixed to two opposing lateral sides of the cover and the base, respectively, without coming into contact with the lip edge portion, the supports each having two arms and a pivot portion connecting with an end of each of the two arms such that other ends of the two arms are fixed to same lateral sides of the cover and the base, respectively, wherein the two arms rotate about the pivot portion such that the cover can be lifted off the base and can cover the base snugly.

7. The car top compartment box of claim 1, wherein the edge of the base extends outward and bends by an angle larger than 90° to form the lip edge portion.

8. The car top compartment box of claim 2, wherein the edge of the base extends outward and bends by an angle larger than 90° to form the lip edge portion.

9. The car top compartment box of claim 3, wherein the edge of the base extends outward and bends by an angle larger than 90° to form the lip edge portion.

10. The car top compartment box of claim 4, wherein the edge of the base extends outward and bends by an angle larger than 90° to form the lip edge portion.

11. The car top compartment box of claim 5, wherein the edge of the base extends outward and bends by an angle larger than 90° to form the lip edge portion.

12. The car top compartment box of claim 6, wherein the edge of the base extends outward and bends by an angle larger than 90° to form the lip edge portion.

13. The car top compartment box of claim 1, wherein the top plate layer is of a thickness of 0.5 mm˜8 mm, the base layer is of a thickness of 0.5 mm˜8 mm, the first polymer foam layer is of a thickness of 2 mm˜10 mm and the second polymer foam layer is of a thickness of 2 mm˜10 mm.

14. The ear top compartment box of claim 2, wherein the top plate layer is of a thickness of 0.5 mm˜8 mm, the base layer is of a thickness of 0.5 mm˜8 mm, the first polymer foam layer is of a thickness of 2 mm˜10 mm and the second polymer foam layer is of a thickness of 2 mm˜10 mm.

15. The car top compartment box of claim 3, wherein the top plate layer is of a thickness of 0.5 mm˜8 mm, the base layer is of a thickness of 0.5 mm˜8 mm, the first polymer foam layer is of a thickness of 2 mm˜10 mm and the second polymer foam layer is of a thickness of 2 mm˜10 mm.

16. The car top compartment box of claim 4, wherein the top plate layer is of a thickness of 0.5 mm˜8 mm, the base layer is of a thickness of 0.5 mm˜8 mm, the first polymer foam layer is of a thickness of 2 mm˜10 mm and the second polymer foam layer is of a thickness of 2 mm˜10 mm.

17. The car top compartment box of claim 5, wherein the top plate layer is of a thickness of 0.5 mm˜8 mm, the base layer is of a thickness of 0.5 mm˜8 mm, the first polymer foam layer is of a thickness of 2 mm˜10 mm and the second polymer foam layer is of a thickness of 2 mm˜10 mm.

18. The car top compartment box of claim 6, wherein the top plate layer is of a thickness of 0.5 mm˜8 mm, the base layer is of a thickness of 0.5 mm˜8 mm the first polymer foam layer is of a thickness of 2 mm˜10 mm and the second polymer foam layer is of a thickness of 2 mm˜10 mm.
